(19) United States
(12) Patent Application Publication
(10) Pub. No.: US 2023/0135032 A1
(43) Pub. Date: May 4, 2023

(54) SYSTEMS AND METHODS FOR A GIFT RECOMMENDATION PLATFORM, ENGINE, AND DYNAMIC USER INTERFACE

(71) Applicant: 143 GIFTCO INC., LARCHMONT, NY (US)

(72) Inventor: BRIDGET JOHNS, LARCHMONT, NY (US)

(21) Appl. No.: 17/812,361

(22) Filed: Jul. 13, 2022

Related U.S. Application Data
(60) Provisional application No. 63/203,222, filed on Jul. 13, 2021.

(51) Int. Cl. G06Q 30/0601; G06Q 50/00; G06Q 30/0203

(52) U.S. Cl. CPC G06Q 30/0631; G06Q 50/01; G06Q 30/0203

(57) ABSTRACT

A computer system for dynamically generating and displaying a product recommendation to a user by analyzing multidimensional attributes associated with users and physical items to generate a unique score for the physical items is described. In one example, a computer system includes an attribute analysis engine to analyze user profile data and assign at least one multidimensional attribute to the user. The attribute analysis engine may also analyze physical items data and assign at least one multidimensional attribute to the physical items. The multidimensional attribute assigned to the physical items may match the multidimensional attribute assigned to the user. In one example, the computer system can dynamically generate a score for the physical items based on the comparison of the multidimensional attribute assigned to the physical items and the multidimensional attribute assigned to the user.

### INCORPORATION BY REFERENCE TO ANY PRIORITY APPLICATIONS

This application claims priority benefit of U.S. Provisional Patent Application No. 63/203,222 filed Jul. 13, 2021, and titled, “SYSTEMS AND METHODS FOR A GIFT RECOMMENDATION PLATFORM, ENGINE, AND DYNAMIC USER INTERFACE”, which is incorporated herein by reference in its entirety.

Any and all applications for which a foreign or domestic priority claim is identified in the Application Data Sheet as filed with the present application are hereby incorporated by reference under 37 CFR 1.57.

### BACKGROUND

### Field

The embodiments of the disclosure generally relate to systems, methods, and devices for a dynamic analysis system and generator, more particularly to systems, methods, and devices for a gift recommendation analysis system, platform, engine, and dynamic user interface.

### Description

Gifts play a pivotal role in daily life. People naturally seek to give gifts to others, but those people may not understand other's preferences. This makes giving gifts a difficult problem. Novel systems and methods for recommending gifts via automatic data collection and algorithmic-based recommendations are needed.

### SUMMARY

For purposes of this summary, certain aspects, advantages, and novel features of the invention are described herein. It is to be understood that not all such advantages necessarily may be achieved in accordance with any particular embodiment of the invention. Thus, for example, those skilled in the art will recognize that the invention may be embodied or carried out in a manner that achieves one advantage or group of advantages as taught herein without necessarily achieving other advantages as may be taught or suggested herein.

In some aspects, a system may dynamically analyze multidimensional attributes associated with a plurality of users and a plurality of physical items and generate a unique score for the plurality of physical items each having a unique ID.

In some aspects, the system may include a database comprising user profile data for each of the plurality of users, wherein the user profile data for each of the plurality of users constitutes a user profile associated with at least one of the plurality of users, a plurality of multidimensional attributes which describe a plurality of possible interests of each of the plurality of users, an attribute analysis system that may be configured to analyze the user profile data stored in the database and dynamically assign to at least one of the plurality of users at least one of the plurality of multidimensional attributes based on analysis of the user profile data associated with at least one of the plurality of users, an Application Programming Interface (API) connection that may be configured to receive a plurality of physical items data about a plurality of physical items and store the plurality of physical items data in an electronic storage medium, the plurality of physical items data received from at least one product source, the attribute analysis system which may further be configured to analyze the plurality of physical items data and dynamically assign to at least one of the plurality of physical items at least one of the plurality of multidimensional attributes based on the analysis of the plurality of physical items data associated with at least one of the plurality of physical items, the attribute analysis system which may further be configured to dynamically generate a score for each one of at least one of the plurality of physical items by comparing at least one of the plurality of multidimensional attributes assigned to at least one of the plurality of physical items to at least one of the plurality of multidimensional attributes assigned to at least one of the plurality of users, the attribute analysis system which may further be configured to output a plurality of recommended physical items based on the score assigned to each of the plurality of physical items, the plurality of recommended physical items having a score satisfying a threshold level, the plurality of recommended physical items outputted in ranked order based on the score associated with the plurality of recommended physical items.

In some aspects, a second API connection may be configured to receive a plurality of social media data about each of the plurality of users and store the plurality of social media data in a second electronic storage medium, the plurality of social media data received from at least one of the plurality of users.

In some aspects, the attribute analysis system may further be configured to analyze the plurality of social media data and the user profile data to dynamically assign to at least one of the plurality of users at least one of the plurality of multidimensional attributes based on analysis of the plurality of social media data and the user profile data associated with at least one of the plurality of users.

In some aspects, the system may further comprise a user profile data generator configured to access a plurality of survey questions stored in a survey bank database and display at least one of the plurality of survey questions to the at least one of the plurality of users, receive a plurality of inputs from at least one of the plurality of users to generate the user profile data for each of the plurality of users.

In some aspects, the user profile data may include at least one of the plurality of inputs from the at least one of the plurality of users.

In some aspects, the plurality of users may include a first user and a second user.

In some aspects, the attribute analysis system may further be configured to increase the score for each one of at least one of the plurality of physical items when at least one of the plurality of multidimensional attributes assigned to at least one of the plurality of physical items equals at least one of the plurality of multidimensional attributes assigned to at least one of the plurality of users.

In some aspects, the attribute analysis system may further be configured to dynamically weigh at least one of the plurality of multidimensional attributes assigned to at least one of the plurality of users.

In some aspects, the attribute analysis system may assign a greater weight to a first multidimensional attribute of the at least one of the plurality of multidimensional attributes than a weight assigned to a second multidimensional attribute of the at least one of the plurality of multidimensional attributes.

In some aspects, the attribute analysis system may further be configured to increase the score for each of the at least one of the plurality of physical items when at least one of the plurality of multidimensional attributes assigned to at least one of the plurality of physical items equals the first multidimensional attribute of the at least one of the plurality of multidimensional attributes.

In some aspects, the plurality of social media data may include a plurality of calendar data.

In some aspects, the system may further include a reminder engine configured to analyze the plurality of calendar data and store at least one calendar item.

In some aspects, the reminder engine may further be configured to generate a reminder based on the at least one calendar item.

Some aspects include a computer system for dynamically generating and displaying a product recommendation to a user by analyzing multidimensional attributes associated with a plurality of users and a plurality of physical items to generate a unique score for the plurality of physical items, each physical item having a unique identification, the computer system comprising: one or more computer readable storage devices configured to store a plurality of computer executable instructions; and one or more hardware computer processors in communication with the one or more computer readable storage devices and configured to execute the plurality of computer executable instructions in order to cause the computer system to: access user profile data associated with a user of the plurality of users, wherein user profile data comprises zero-party data obtained via a dynamic user interface; analyze, by an attribute analysis engine, user profile data to assign at least one of a plurality of multidimensional attributes to the user, wherein each of the plurality of multidimensional attributes comprises at least one of: character trait, character attribute, demographic, preference, trend, interest, descriptive label, or location; receive, via an application programming interface from at least one third-party source, a plurality of physical items data associated with a plurality of physical items; store the plurality of physical items data; analyze, by the attribute analysis engine, the plurality of physical items data to assign at least one of the plurality of multidimensional attributes to at least one of the plurality of physical items; dynamically generate, by the attribute analysis engine, a score for each of the at least one of the plurality of physical items by comparing the at least one of the plurality of multidimensional attributes assigned to the at least one of the plurality of physical items to the at least one of the plurality of multidimensional attributes assigned to the user; and display, via the dynamic user interface, a plurality of recommended physical items based on the score assigned to each of the at least one of the plurality of physical items, wherein the plurality of recommended physical items have a score exceeding a threshold level, and wherein the plurality of recommended physical items are displayed in order based on the generated score.

In some embodiments, a second application programming interface connection interface is configured to receive a plurality of social media data about each of the plurality of users and store the plurality of social media data in a second electronic storage medium, the plurality of social media data received from at least one of the plurality of users.

In some embodiments, the attribute analysis engine is further configured to analyze the plurality of social media data and the user profile data to dynamically assign to at least one of the plurality of users at least one of the plurality of multidimensional attributes based on analysis of the plurality of social media data and the user profile data associated with at least one of the plurality of users.

In some embodiments, the system further comprises a user profile data generator configured to access a plurality of survey questions stored in a survey bank database and display at least one of the plurality of survey questions to the at least one of the plurality of users, receive a plurality of inputs from at least one of the plurality of users to generate the user profile data for each of the plurality of users. In some embodiments, the user profile data includes at least one of the plurality of inputs from the at least one of the plurality of users.

In some embodiments, the plurality of users includes a first user and a second user. In some embodiments, the attribute analysis engine is further configured to increase the score for each one of at least one of the plurality of physical items when at least one of the plurality of multidimensional attributes assigned to at least one of the plurality of physical items equals at least one of the plurality of multidimensional attributes assigned to at least one of the plurality of users. In some embodiments, the attribute analysis engine is further configured to dynamically weigh at least one of the plurality of multidimensional attributes assigned to at least one of the plurality of users.

In some embodiments, the attribute analysis engine assigns a greater weight to a first multidimensional attribute of the at least one of the plurality of multidimensional attributes than a weight assigned to a second multidimensional attribute of the at least one of the plurality of multidimensional attributes. In some embodiments, the attribute analysis engine is further configured to increase the score for each of the at least one of the plurality of physical items when at least one of the plurality of multidimensional attributes assigned to at least one of the plurality of physical items equals the first multidimensional attribute of the at least one of the plurality of multidimensional attributes.

In some embodiments, the plurality of social media data includes a plurality of calendar data. In some embodiments, the computer system further comprises a reminder engine configured to analyze the plurality of calendar data and store at least one calendar item. In some embodiments, the reminder engine is further configured to generate a reminder based on the at least one calendar item.

Some aspects include a computer-implemented method for dynamically generating and displaying a product recommendation to a user by analyzing multidimensional attributes associated with a plurality of users and a plurality of physical items to generate a unique score for the plurality of physical items each physical item having a unique identification, the computer-implemented method comprising: collecting user profile data for each of the plurality of users and storing the user profile data in one or more computer readable storage devices configured to store a plurality of computer executable instructions; accessing user profile data associated with a user of the plurality of users, wherein the user profile data comprises zero-party data obtained via a dynamic user interface; analyzing, by an attribute analysis engine, the user profile data to assign at least one of a plurality of multidimensional attributes to the user, wherein each of the plurality of multidimensional attributes comprises at least one of: character trait, character attribute, demographic, preference, trend, interest, descriptive label, or location; receiving, via an application programming interface from at least one third-party source, a plurality of physical items data associated with a plurality of physical items; storing the plurality of physical items data; analyzing, by the attribute analysis engine, the plurality of physical items data to assign at least one of the plurality of multidimensional attributes to at least one of the plurality of physical items; dynamically generating, by the attribute analysis engine, a score for each of the at least one of the plurality of physical items by comparing the at least one of the plurality of multidimensional attributes assigned to the at least one of the plurality of physical items to the at least one of the plurality of multidimensional attributes assigned to the user; and displaying, via the dynamic user interface, a plurality of recommended physical items based on the score assigned to each of the at least one of the plurality of physical items, wherein the plurality of recommended physical items have a score exceeding a threshold level, and wherein the plurality of recommended physical items are displayed in order based on the generated score.

In some embodiments, a second API connection interface receiving a plurality of social media data about each of the plurality of users and storing the plurality of social media data in a second electronic storage medium, the plurality of social media data received from at least one of the plurality of users.

In some embodiments, the attribute analysis engine analyzing the plurality of social media data and the user profile data and dynamically assigning to at least one of the plurality of users at least one of the plurality of multidimensional attributes based on analysis of the plurality of social media data and the user profile data associated with at least one of the plurality of users. In some embodiments, the attribute analysis engine increasing the score for each one of the at least one of the plurality of physical items when at least one of the plurality of multidimensional attributes assigned to at least one of the plurality of physical items equals at least one of the plurality of multidimensional attributes assigned to at least one of the plurality of users.

In some embodiments, the attribute analysis engine dynamically weighing at least one of the plurality of multidimensional attributes assigned to at least one of the plurality of users. In some embodiments, the attribute analysis engine assigning a greater weight to a first multidimensional attribute of the at least one of the plurality of multidimensional attributes than a weight assigned to a second multidimensional attribute of the at least one of the plurality of multidimensional attributes.

In some embodiments, the attribute analysis engine increasing the score for each of the at least one of the plurality of physical items when at least one of the plurality of multidimensional attributes assigned to at least one of the plurality of physical items equals the first multidimensional attribute of the at least one of the plurality of multidimensional attributes.

### BRIEF DESCRIPTION OF THE DRAWINGS

The drawings are provided to illustrate example embodiments and are not intended to limit the scope of the disclosure. A better understanding of the systems and methods described herein will be appreciated upon reference to the following description in conjunction with the accompanying drawings, wherein:

FIG. 1 illustrates a diagram of a system configured to provide a consumer experience according to some embodiments.

FIG. 2 illustrates a diagram of a system configured to provide a gift giver experience according to some embodiments.

FIGS. 3-24 illustrate example dynamic application interfaces according to some embodiments.

FIG. 25 is a schematic diagram illustrating an example embodiment(s) of a gift recommendation generating system.

FIG. 26 is a block diagram that illustrates an example protocol or method 2000 for a system that analyzes a plurality of multidimensional attributes assigned to users and physical.

FIG. 27 is a block diagram illustrating a computer hardware system configured to run software for implementing one or more embodiments of a gift recommendation engine according to some embodiments.

### DETAILED DESCRIPTION

Although several embodiments, examples, and illustrations are disclosed below, it will be understood by those of ordinary skill in the art that the inventions described herein extend beyond the specifically disclosed embodiments, examples, and illustrations and includes other uses of the inventions and obvious modifications and equivalents thereof. Embodiments of the inventions are described with reference to the accompanying figures, wherein like numerals refer to like elements throughout. The terminology used in the description presented herein is not intended to be interpreted in any limited or restrictive manner simply because it is being used in conjunction with a detailed description of certain specific embodiments of the inventions. In addition, embodiments of the inventions can comprise several novel features and no single feature is solely responsible for its desirable attributes or is essential to practicing the inventions herein described.

Although certain preferred embodiments and examples are disclosed below, inventive subject matter extends beyond the specifically disclosed embodiments to other alternative embodiments and/or uses and to modifications and equivalents thereof. Thus, the scope of the claims appended hereto is not limited by any of the particular embodiments described below. For example, in any method or process disclosed herein, the acts or operations of the method or process may be performed in any suitable sequence and are not necessarily limited to any particular disclosed sequence. Various operations may be described as multiple discrete operations in turn, in a manner that may be helpful in understanding certain embodiments; however, the order of description should not be construed to imply that these operations are order dependent. Additionally, the structures, systems, and/or devices described herein may be embodied as integrated components or as separate components. For purposes of comparing various embodiments, certain aspects and advantages of these embodiments are described. Not necessarily all such aspects or advantages are achieved by any particular embodiment. Thus, for example, various embodiments may be carried out in a manner that achieves or optimizes one advantage or group of advantages as taught herein without necessarily achieving other aspects or advantages as may also be taught or suggested herein.

Certain exemplary embodiments will now be described to provide an overall understanding of the principles of the structure, function, manufacture, and use of the devices and methods disclosed herein. One or more examples of these embodiments are illustrated in the accompanying drawings. Those skilled in the art will understand that the devices and methods specifically described herein and illustrated in the accompanying drawings are non-limiting exemplary embodiments and that the scope of the present invention is defined solely by the claims. The features illustrated or described in connection with one exemplary embodiment may be combined with the features of other embodiments. Such modifications and variations are intended to be included within the scope of the present technology.

Curating or selecting the perfect gift for an occasion can be frustrating and stressful for a gift giver. As such, it would be beneficial to eliminate or minimize the human element of selection in the gift giving experience. While individuals may put a lot of thought into the gift selected for the gift receiver, the gift receiver may not appreciate the gift selected for various reasons. For example, the gift selected may no longer be of taste to the gift receiver, the life event the gift may apply to may have already past for the gift receiver, etc. However, there are great difficulties in removing the human element in gift giving and still giving a gift the gift receiver may enjoy.

It was important to create a single computer system and method that can mimic the thought a human would put into gift selection. For example, it was important to consider what a gift giver may inquire about regarding the gift receiver when selecting a gift, why a gift giver may be giving a gift, and where a gift giver may look for a gift, etc. It is currently technically impossible to do this because the gift possibilities for a gift giver to gift to a gift receiver are endless. It was important to implement a system or method that would efficiently and tactically analyze and categorize each gift possibility and determine the best gift for each gift receiver. In this manner, human elements can be mimicked in a computer system in an efficient manner.

### Gift Recommendation Engine

In some embodiments, the system may comprise a gift recommendation engine, which combines disparate data sources to deliver targeted suggestions to gift givers and provides a seamless gifting experience. The recommendation engine may assist a user in the suggestion of items, products, services and contents, partially or fully automatically, according to the user's or a giftee's interests and needs. In some embodiments, the system may provide information that helps the user in the decision making of which items to choose, which can be, for example, books, music, movies, or other products. In some embodiments, the system may, based on a user's or a giftee's profile, suggest items to the user directly without the being prompted by the user, such as gifts that the user or giftee may have interest based on a user or giftee profile. In some embodiments, the system may utilize input data from the user, the input data used to make recommendations and direct gifts to the relevant giftee.

In some embodiments, the system is configured to provide a gift giver user experience using a dynamic user interface. In some embodiments, the dynamic user interface (DUI) implements a flexible graphical user interface programming toolkit to define a representation of the gift recommendation system forms, that can be displayed on one or more display devices of a user. In some embodiments, the user interface serves as the point of user-computer interaction and communication with the gift recommendation systems. In some embodiments, the user can interact with the DUI via one or more input devices, which can include, for example, touch-screen display screens, keyboards, or a mouse, among others. In some embodiments, the DUI may comprise a graphical user interface (GUI), including elements such as, for example, windows, pull-down menus, buttons, scroll bars and icons. In some embodiments, the GUI may comprise one or more multimedia elements, such as sound, voice, motion video, and virtual reality, among others.

In some embodiments, the system is configured to obtain user or giftee (i.e., gift recipient) input, via the dynamic user interface, to obtain user or giftee information. In some embodiments, the user input may be obtained in response to one or more presented questions to a gift recipient to obtain one or more of the following information from the gift recipient: his/her birthday date, date of anniversary, whether he/she has kids, whether he/she enjoys traveling or staying at home, whether he/she likes the city or the country, the last place he/she bought something for himself/herself, among others. In some embodiments, the system can be configured to align such questions with ratings to indicate which questions will maximize the facilitation of gift selection. In some embodiments, the information provided by the user or gift recipient may be used to create a user profile for the gift recipient.

In some embodiments, the system may include an attribute analysis system. The attribute analysis system may be configured to analyze the information provided by the gift recipient and dynamically assign at least one multidimensional attribute to the gift recipient associated with the user profile created for the gift recipient. Such multidimensional attributes may include character traits, character attributes, demographics, likes or dislikes, trends, interests, descriptive labels, climate location, etc. For example, a multidimensional attribute may comprise a favorite color, a hobby, a favorite pattern, a style, etc. In some embodiments, at least one of the multidimensional attributes may be derived from the gift recipient or may include zero party data. Zero-party data is that which a user intentionally and proactively shares with the system via the dynamic user interface. Zero party data may include preference data, purchase intentions, and personal context, among others. In some embodiments, one multidimensional attribute may be given a greater weight in the recommendation system than another multidimensional attribute. For example, a gift recipient's favorite color may be more important than the gift recipient's style when generating a gift recommendation in certain embodiments. In some embodiments, the system may continuously or periodically check for new information that may be inputted by the user which may then be analyzed by the attribute analysis system.

In some embodiments, the system may include an application programming interface (API) connection, which may be configured to receive a plurality of product or physical items data associated with a product or physical item. In some embodiments, the API may comprise a mechanism that enables the recommendation system to communicate with one or more third-party websites or applications using a set of definitions and protocols. The physical item may be a potential gift for the gift recipient. In some embodiments, the attribute analysis system may analyze the physical items data and dynamically assign at least one multidimensional attribute to the physical items data associated with each physical item. In some embodiments, each of the multidimensional attributes assigned to the physical item may be descriptive of the physical item. In some embodiments, the system may continuously receive a plurality of physical item data associated with a physical item via one or more API integrations.

In some embodiments, the attribute analysis system may be configured to compare each of the multidimensional attributes dynamically assigned to the physical item data associated with the physical item and the multidimensional attributes dynamically assigned to the information associated with the user profile created for the gift recipient to match the physical items with gift recipients for recommendation generation. In some embodiments, the attribute analysis system may determine whether any of the multidimensional attributes dynamically assigned to the physical item data associated with the physical item match with one or more of the multidimensional attributes dynamically assigned to the information associated with the user profile created for the gift recipient. For example, a match may imply that the gift recipient may enjoy or want the physical item as a gift. In some embodiments, the multidimensional attributes dynamically assigned to the physical item data associated with the physical item may allow the physical item to match with the multidimensional attributes dynamically assigned to the information associated with the user profile created for the gift recipient more than once.

In some embodiments, the attribute analysis system may further be configured to dynamically generate a score, for each user, for each one of the physical items based on the comparison of the multidimensional attributes dynamically assigned to the physical item data associated with the physical item and the multidimensional attributes dynamically assigned to the information associated with the user profile created for the gift recipient. In some embodiments, the score assigned to a physical item can increase or decrease over time depending on the changing interests of the gift recipient and/or updates to the assignment of multidimensional attributes to the physical item.

In some embodiments, the attribute analysis system may be further configured to transmit, automatically (e.g., periodically) or upon request, to the gift giver, a curated list of suggested gifts at a specified time period prior to a gift giving occasion. For example, the curated list may be transmitted to the gift giver during a period 1-2 weeks, 3-6 weeks, 7-12 weeks, 14-52 weeks prior to a gift giving occasion. In some embodiments, the curated list may be in ranked order based on the score generated for each of the products. In some embodiments, the curated list may be transmitted to the gift giver at any time prior to or on the gift giving occasion. In some embodiments, the system is configured to provide the gift giver with visual cues about the gifts. In some embodiments, the system may be configured to enable the gift giver to set one or more parameters for the gift. For example, the gift giver may choose the gift price range and the gift giving frequency via the dynamic user interface. In some embodiments, the system may enable the gift giver to change the gift parameters and gift recipient settings at any time. In some embodiments, the system may automatically transmit an updated curated list of suggested gifts upon a change in the gift parameters or gift recipient settings.

In some embodiments, the system may be configured to provide a user experience via the dynamic user interface. In some embodiments, the user experience encompasses all aspects of the user's interaction with the system and the dynamic user interface. In some embodiments, the system is configured to provide one or more gift options to the gift giver. In some embodiments, the system may be configured to deliver gift recommendations to the gift giver. In some embodiments, the gift giver may be provided with an opportunity to choose between several options to choose the gift they would like to give to a gift recipient. In some embodiments, the gift giver may be able to purchase the gift directly through the system via the dynamic user interface. For example, the system can provide a direct to consumer (e.g., D2C) experience for the gift giver. In some embodiments, the systems may provide one or more gift options to a gift giver, wherein the gifts may be categorized in one or more tiers, such that users with high engagement, or based on other metrics, may receive one or more gift recommendations in a higher tier. In some embodiments, the system can be configured to build new gifting opportunities.

In some embodiments, the system may be configured to collect, use, and track gift feedback from the gift recipient. In some embodiments, the system can be configured to collect gift feedback from the gift recipient through a text-image interface of the dynamic user interface. In some embodiments, the system can be configured to use the gift feedback collected from the gift recipient, including social media sentiment, to update the gift recipient settings, such as their interests, occupation, social media presence, engagement level, or otherwise. In some embodiments, the system can be configured to make notes in a recipient profile based on the gift feedback collected from the gift recipient. In some embodiments, the system can be configured to derive self-learnings about the gift recipient's interests and automatically update the gift recipient's interest settings by tracking the gift recipient's structured feedback.

In some embodiments, the system may be configured to demonstrate to the user that the giftee persona can be sufficiently or adequately described, fit or provided for. For example, user question prompts may assist the user in describing another user whom they may be gifting. For example, such question prompts can include inquiring how the user lives, what the user's style is, what the user is into. In some embodiments, question prompts or answer categories can be accompanied by images that may correlate to the question or answer category.

In some embodiments, the system may be configured to demonstrate to the user that the gifter intent can be sufficiently or adequately described, fit, or provided for. For example, user question prompts may assist the user in conveying their gifting intent. For example, the user may have a gifting preference wherein the user tells the system, wherein the system may guide the user, wherein the system may tell the user, etc. The user may select a category of interest for gifting, which may include the category where the system may generate a gift recommendation from.

In some embodiments, the system may be configured to demonstrate to the user that the sufficient or user-liked brands can be selected. For example, the system may provide brands for each category of interest which the user may select. In some embodiments, the selection of the user may be analyzed by the system when generating the gift recommendation.

### Dynamic User Interface

In some embodiments, the system may comprise a dynamic user interface comprising a home page/marketing page, which may comprise, for example, a splash page with a value proposition and explanation of service. In some embodiments, the home page/marketing page further comprises a call to action (CTA) leading to the signup page and a link to contact customer service.

In some embodiments, the interface comprises a signup flow page, which instructs a new gift giver to provide user information, gift recipient information, payment information and/or order confirmation. In some embodiments, the gift giver information may include name, contact information, ID and/or password, among others. In some embodiments, the gift recipient information may include contact information, demographic information, interest information, occasion information and/or service tier, among others. In some embodiments, the payment information may include credit card information.

In some embodiments, the interface may comprise an account page, which may include the gift giver's list of gift recipients and recipient settings unique to each gift recipient. In some embodiments, the gift recipient settings may include the following information regarding each gift recipient: contact information, demographic information, interest information, occasion information and/or service tier.

In some embodiments, the system is configured to generate signup reports automatically, periodically, or manually for an administrator. In some embodiments, a signup report may include the following information: a list of users who has signed up during a given period, each signup date, the users' settings, product information, and monthly user engagement rate. In some embodiments, the system may be configured to transmit data to one or more gift sources, wherein each gift source comprises an entity from which gifts are sourced. In some embodiments, this data may include details about gift recipients and their preferences. In some embodiments, users of the system be given the option of allowing user data to be transmitted to third-parties, or restricting transmission of user data.

In some embodiments, the system is configured to generate billing reports automatically, periodically, or manually to the administrator. In some embodiments, a billing report may include the following information: a list of payments processed by date, a list of payments declined by date, and/or a list of refunds processed by date.

In some embodiments, the system can be configured to automatically, periodically, or manually present gift fulfillment workflows to the administrator. In some embodiments, a gift fulfillment workflow comprises an upcoming gifts section, which may include the following information: a list of gift recipients, gift recipient interest information, and gift shipping dates. In some embodiments, a gift fulfillment workflow may comprise a fulfilled gifts section, which may include the record of gifts sent to gift recipients. In some embodiments, a gift fulfillment workflow comprises a message sent section, which may include messages sent to the gift givers and/or the gift recipients.

In some embodiments, the system is configured to generate gift feedback reports automatically, periodically, or manually to the administrator. In some embodiments, a gift feedback report may include gift recipient ratings and feedback details for the gifts received by each gift recipient.

In some embodiments, the system is configured to enable a messaging function. In some embodiments, the system is configured to send e-mails or another form of electronic communication to customers when there is an enrollment/order confirmation. In some embodiments, the system is configured to send gift notifications to the gift givers. In some embodiments, the system is configured to send gift notifications and feedback solicitations to gift recipients.

### Gift Recommendation Framework

In some embodiments, the system is configured to collect one or more of the following inputs from the gift giver: the name of the gift recipient, the gifting occasion, and/or a budget for the gift. In some embodiments, the system is configured to collect one or more of the following inputs from the gift recipient: a selection of whether he/she wants to give input, and whether he/she gives his/her permission to access data pertaining to the gift recipient. This data may be obtained via cookies, third-party websites, such as social media websites, or otherwise. Such data may be used to create a user profile for the gift recipient. In some embodiments, the system is configured to collect one or more of the following inputs from third parties: the gift recipient's previous self-purchases, previous gifts sent to the gift recipient, the gift recipient's wish list items. In some embodiments, the system is configured to upload the information collected from third parties to one or more databases and align such information to the gift recipient's persona. The information collected may allow the system to assign various multidimensional attributes to the gift recipient or the user profile associated with the gift recipient. In some embodiments, the system may be able to assign a greater weight a multidimensional attribute compared to other multidimensional attributes based on the information collected. This may allow the system to generate a higher score for a product compared to other products. For example, the system may assign a greater weight to a multidimensional attribute if the system determines, through the information collected, that a major or minor life event occurred for the gift recipient, the gift recipient recently developed a new hobby, etc.

In some embodiments, the system may include a reminder engine, which may be configured to remind the gift giver when a gift recipient may be gifted. In some embodiments, the reminder engine may be configured to analyze information provided by the gift recipient to determine whether an event is approaching. In some embodiments, the reminder may include a notification provided by the system to the gift giver.

In some embodiments, the system is configured to enable manual curation and data collection. In some embodiments, the system can be configured to incorporate Artificial Intelligence/Machine Learning (AI/ML) into the system to collect data and/or to provide gifting recommendations. In some embodiments, the system can be configured to collect data about the gift recipient from Facebook, WhatsApp, Instagram, Pinterest and/or TikTok, among others.

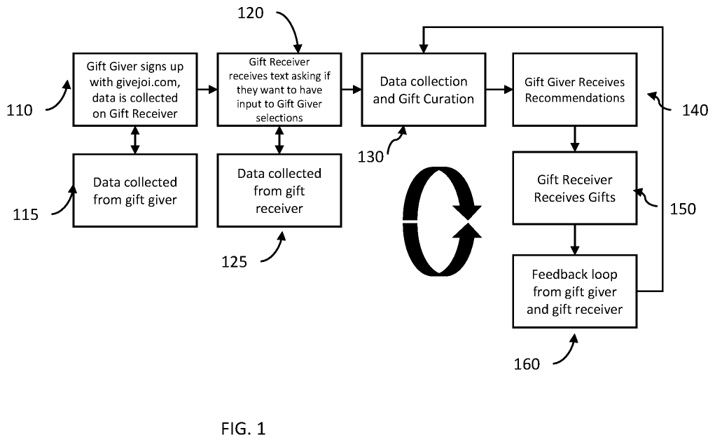

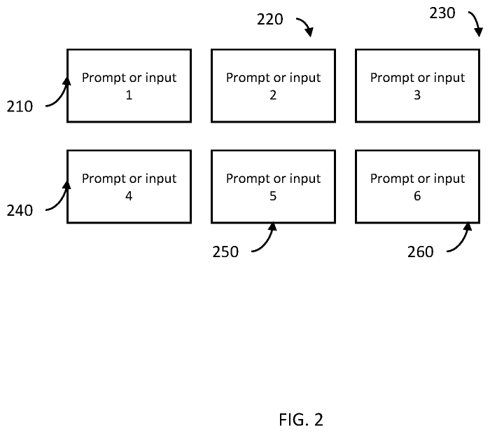

In some embodiments, the system is configured to provide a consumer experience as illustrated in FIG. 1. In some embodiments, the system is configured to provide a gift giver experience as illustrated in FIG. 2.

In some embodiments, the system may provide a gifting recommendation platform focused on democratizing gifting for digital natives and other vertical brands. In some embodiments, the system creates a contextual consumer commerce/informed search platform to help users give better gifts.

In some embodiments, the system may provide the first AI-based platform for consumer gifting. In some embodiments, the system may provide gift givers with better gifting recommendations, provide gift recipients with better gifts, and enable brands to attract new customers by building the right connections between gift givers, gift recipients and brands.

In some embodiments, the system may remove friction from the gifting experience to help people give and receive better gifts.

FIG. 1 illustrates a schematic of an example embodiment of a system for a gift recommendation engine. At block 110, a gift giver may sign up or create an account with a platform such as givejoi.com. Simultaneously, at block 115, the system may collect data from the gift giver. At block 120 data about the gift receiver may be included. Simultaneously, at block 125, the system may collect data from the gift receiver. Such data may include data regarding birthdate, anniversaries, upcoming events, holidays, characteristics, traits, likes, dislikes, recent purchases, memberships, responses to platform provided questionnaires, gift price points or ranges, etc. Such data may be collected from a calendar, email account, social media, cookies, partnerships, platform provided questionnaires, etc. For example, such platform provided questionnaires may include visual quiz on aesthetics, size questions, brand affinity questions, permission to see brands on Instagram, Pinterest, or other social media platforms, inquiries regarding recent hobbies or purchases, future plans or engagements, etc. In some embodiments, the gift receiver may receive a text message asking whether the gift receiver wants to have input on the gift giver's gift selection. At block 130, the system the data collected may contribute to gift curation. At block 140, the gift giver may receive a recommendation from the system. At block 150, the gift receiver may receive the gift recommended to the gift giver by the system. At block 160, the system may further collect data from a feedback loop from the gift giver and the gift receiver.

FIG. 2 illustrates an example embodiment of a gift giver user interface. In some embodiments, the gift giver user interface may include prompts or questions for the gift giver to answer that may generate data to be collected and stored within a database. For example, such prompt or questions may include questions pertaining to the gift receiver's birthdate or other event dates, budget, the relationship the gift giver may have with the gift receiver, the occasion, style of the gift receiver. As shown in FIG. 2, a prompt or input one 210, a prompt or input two 220, a prompt or input three 230, a prompt or input four 240, a prompt or input five 250, a prompt or input six 260 may be presented to the user. For example, prompt or input one 210 may include “so you want to give better gifts? Help us help you!” For example, prompt or input two 220 may include “what is their birthday? Any other special days you'd like to note?” For example, prompt or input three 230 may include “do you have a budget in mind? Yes/No; Yes: >$200, $100-200, <$100”. For example, prompt or input four 240 may include “who are you shopping for? Name ______; Wife; Husband; Girlfriend; Boyfriend; Other ______” For example, prompt or input five 250 may include “what's the occasion? Birthday; Christmas/Hanukkah/Kwanza; Anniversary; Other ______.” For example, prompt or input six may 260 may include “Choose the picture that best represents your giftee's style.”

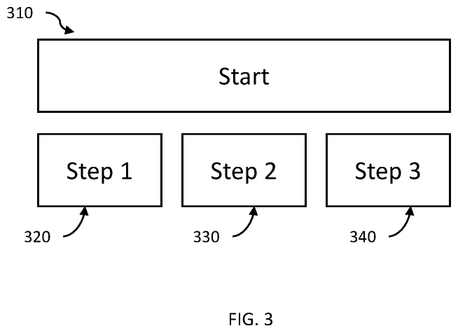

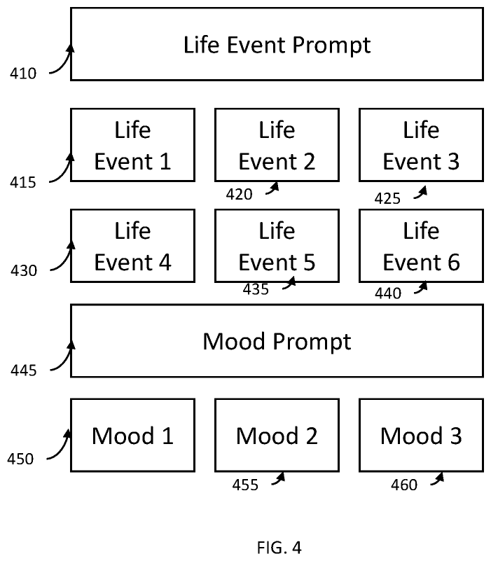

FIG. 3 and FIG. 4 illustrates example embodiments of a user interface. In some embodiments, the user interface may include an introduction that may explain the steps that the user may take to give or receive great gifts. In some embodiments, the user interface may include icons and questions that may allow the user to easily answer the question prompted. In some embodiments, the icon may correlate to the question prompted. As shown in FIG. 3, start 310 can allow the user to begin to use the user interface. The user can begin at step 1 320, proceed to step 2 330, and proceed to step 3 340. For example, step 1 320 may include creating a gifting profile, step 2 330 may include sharing it with your friends, step 3 340 may include enjoying great gifts.

As shown in FIG. 4, a life event prompt 410 may be presented to the user. The user may be shown life event options, such as life event one 415, life event two 420, life event three 425, life event four 430, life event five 435, life event six 440. For example, the life event options can include marriage, new home, new baby, retirement, job changes, other, etc. As shown in FIG. 4, a mood prompt 445 may be presented to the user. The user may be shown mood options, such as mood one 450, mood two 455, and mood three 460. For example, the mood options can include excited, chill, and stressed.

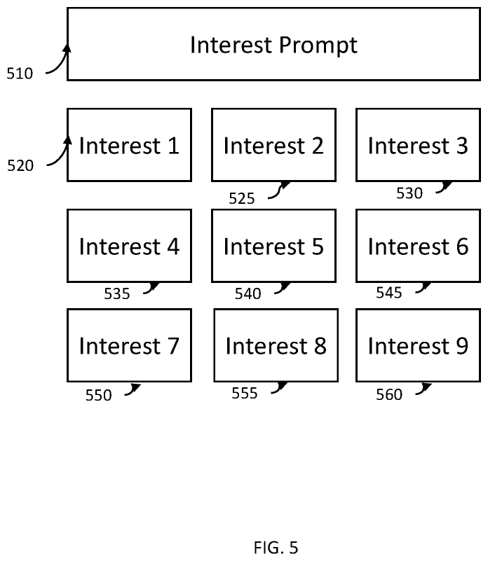

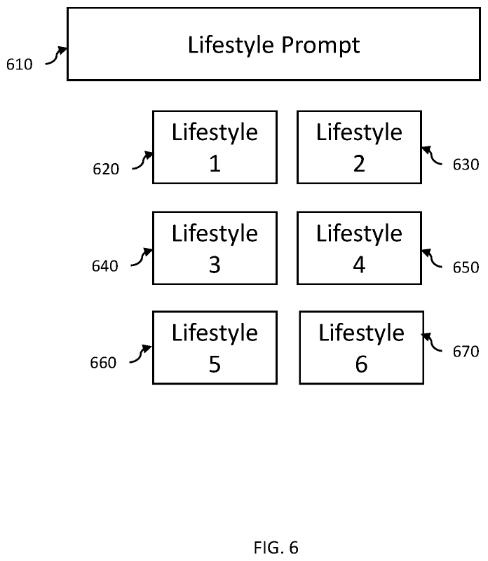

FIG. 5 and FIG. 6 illustrates example embodiments of a user interface. In some embodiments, the user interface may include icons and questions that may allow the user to easily answer the question prompted. In some embodiments, the icon may correlate to the question prompted. For example, the user interface may include a prompt inquiring what topics the user may be interested in currently. Similarly, for example, the user interface may include a prompt inquiring what activities the user may participate in throughout or during a normal day, or on a weekend, or in their free time.

As shown in FIG. 5, an interest prompt 510 may be presented to the user. The user may be shown interest options, such as interest one 520, interest two 525, interest three 530, interest four 535, interest five 540, interest six 545, interest seven 550, interest eight 555, interest nine 560. For example, the interest options can include travel, self-care, fitness, cooking, art, wine, entertaining, pets, other, etc.

As shown in FIG. 6, a lifestyle prompt 610 may be presented to the user. The user may be shown lifestyle options, such as lifestyle one 620, lifestyle two 630, lifestyle three 640, lifestyle four 650, lifestyle five 660, lifestyle six 670. For example, the lifestyle options can include building an empire, self-improvement, future investing, enjoying the good life, etc.

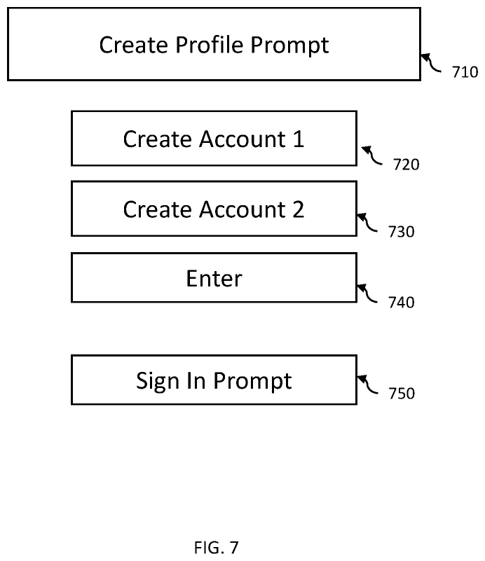

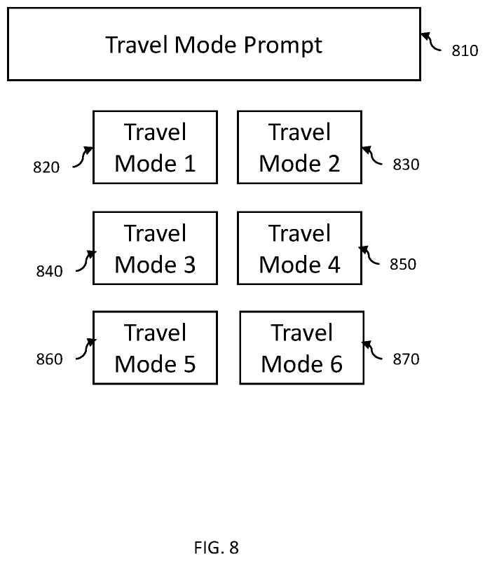

FIG. 7 and FIG. 8 illustrates example embodiments of a user interface. In some embodiments, the user interface may include a profile set up prompt. This may provide a user interface to allow the user to create a profile. In some embodiments, the user interface may include icons and questions that may allow the user to easily answer the question prompted. In some embodiments, the icon may correlate to the question prompted. For example, the user interface may include a prompt inquiring what mode of travel is usual for the user.

As shown in FIG. 7, a create profile prompt 710 may be presented to the user. The user may be able to input account information in create account one 720 and create account two 730 to create a profile. The user may select Enter 740 to continue with profile creating. The user may Sign In 750 if a profile is already created.

As shown in FIG. 8, a travel mode prompt 810 may be presented to the user. The user may be shown travel mode options, such as travel mode one 820, travel mode two 830, travel mode three 840, travel mode four 850, travel mode five 860, travel mode six 870. For example, the travel mode options can include jet setting, camping, road tripping, beach, relaxing at home, adventure, etc.

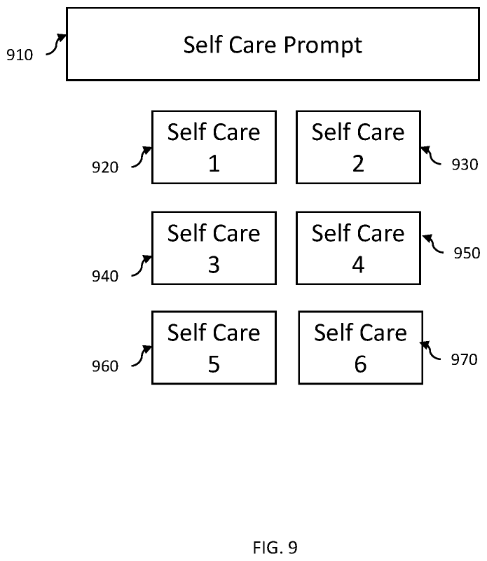

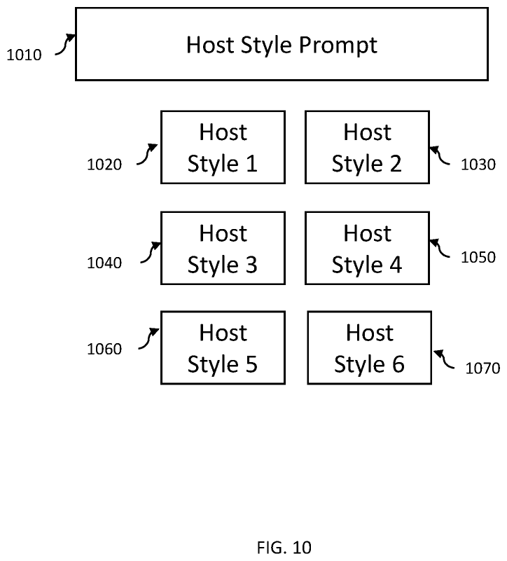

FIG. 9 and FIG. 10 illustrate example embodiments of a user interface. In some embodiments, the user interface may include icons and questions that may allow the user to easily answer the question prompted. In some embodiments, the icon may correlate to the question prompted. For example, the user interface may include a prompt inquiring what mode of self-care is usual for the user. Similarly, for example, the user interface may include a prompt inquiring what the host style of the user may be.

As shown in FIG. 9, a self-care prompt 910 may be presented to the user. The user may be shown self-care options, such as self-care one 920, self-care two 930, self-care three 940, self-care four 950, self-care five 960, self-care six 970. For example, the self-care options can include working on body, connecting with friends, getting pampered, working on mind, finding inner peace, hitting the stores, etc.

As shown in FIG. 10, a host style prompt 1010 may be presented to the user. The user may be shown host style options, such as host style one 1020, host style two 1030, host style 1040, host style four 1050, host style five 1060, host style six 1070. For example, the host style options can include backyard barbeque, playdates, dinner party, holiday hosting, game night, big events, etc.

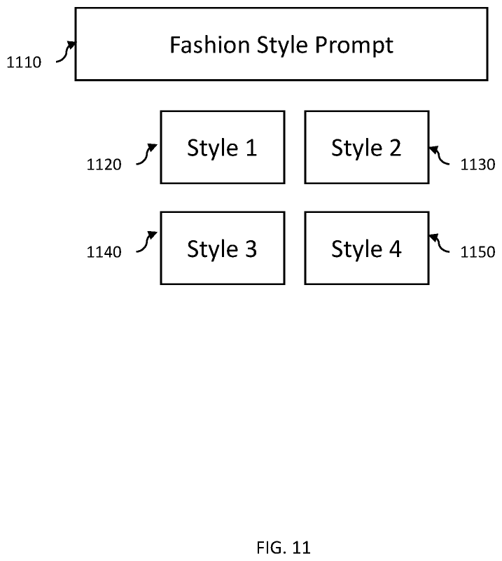

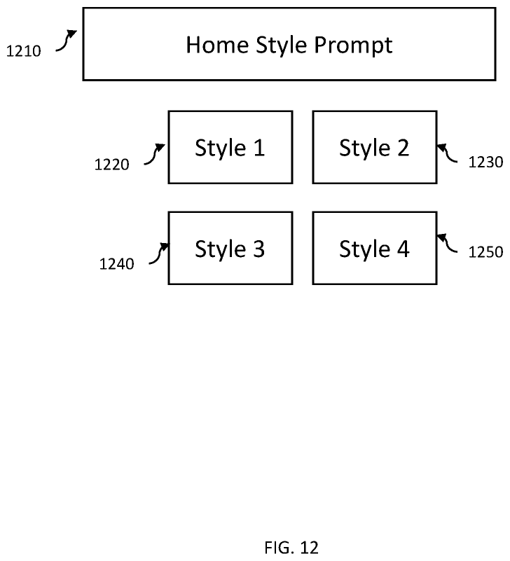

FIG. 11 and FIG. 12 illustrate example embodiments of a user interface. In some embodiments, the user interface may include icons and questions that may allow the user to easily answer the question prompted. In some embodiments, the icon may correlate to the question prompted. For example, the user interface may include a prompt inquiring what the fashion style of the user may be. Similarly, for example, the user interface may include a prompt inquiring what home design style of the user may be.

As shown in FIG. 11, a fashion style prompt 1110 may be presented to the user. The user may be shown style options, such as style one 1120, style two 1130, style three 1140, style four 1150. For example, the style options can include classic, bohemian, designer, casual, etc.

As shown in FIG. 12, a home style prompt 1210 may be presented to the user. The user may be shown style options, such as style one 1220, style two 1230, style three 1240, style four 1250. For example, the style options can include contemporary, modern, eclectic, rustic, etc.

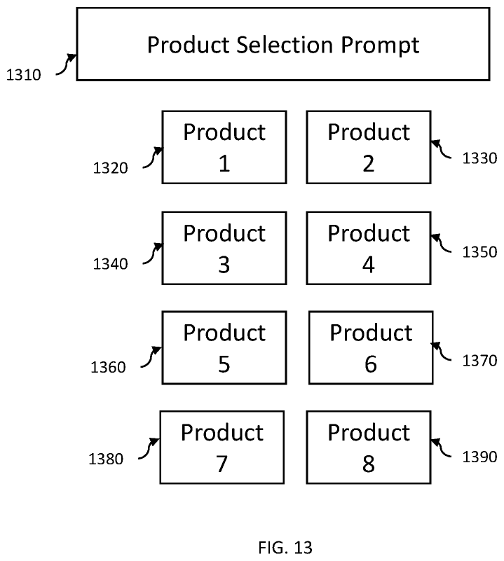

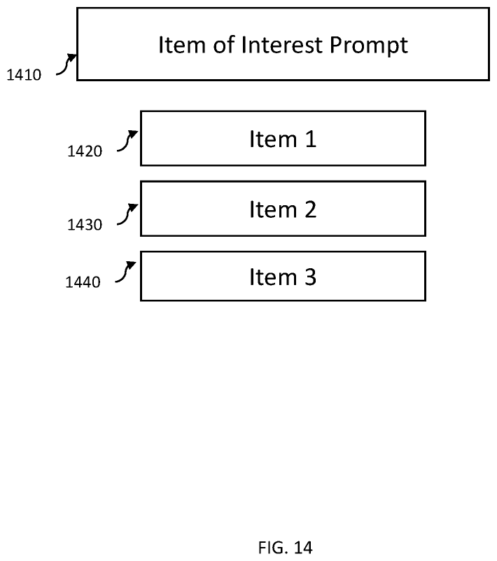

FIG. 13 and FIG. 14 illustrate example embodiments of a user interface. In some embodiments, the user interface may include icons and questions that may allow the user to easily answer the question prompted. In some embodiments, the icon may correlate to the question prompted. For example, the user interface may include a prompt inquiring which products the user enjoyed or liked best. Similarly, for example, the user interface may include a functionality that may allow the user to input links to material items, gifts, or experiences the user may be interested in.

As shown in FIG. 13, a product selection prompt 1310 may be presented to the user. The user may be shown product options, such as product one 1320, product two 1330, product three 1340, product four 1350, product five 1360, product six 1370, product seven 1380, product eight 1390.

As shown in FIG. 14, an item of interest prompt 1410 may be presented to the user. The user can input links to product the user may be interested in themselves. For example, the user can input a link for item one 1420, item two 1430, item three 1440.

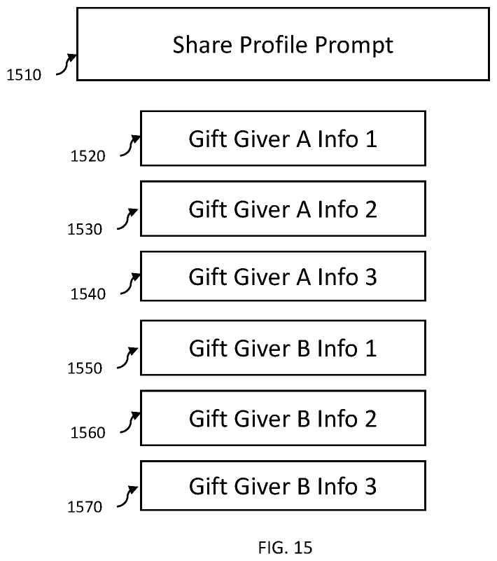

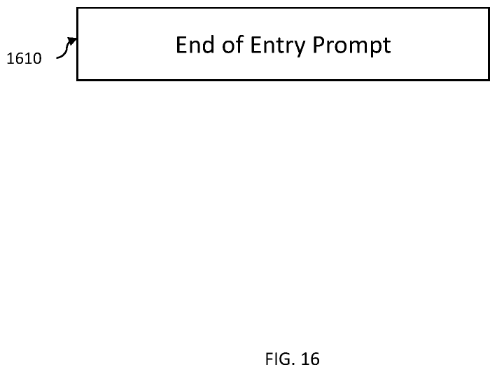

FIG. 15 and FIG. 16 illustrate example embodiments of a user interface. In some embodiments, the user interface may include icons and questions that may allow the user to easily answer the question prompted. In some embodiments, the user interface may include a functionality that may allow the user to input contact information for where or who the user profile should be sent to.

As shown in FIG. 15, a share profile prompt 1510 may be presented to the user. The user can input gift giver information for each gift giver. The user can input information for gift giver A into gift giver A info one 1520, gift giver A info two 1530, gift giver A info three 1540. The user can input information for gift giver B into gift giver A info one 1550, gift giver A info two 1560, gift giver A info three 1570. Such gift giver info can include name, email, phone number, etc.

As shown in FIG. 16, an end of entry prompt 1610 may be presented to the user. For example, the end of entry prompt 1610 may include “thank you.”

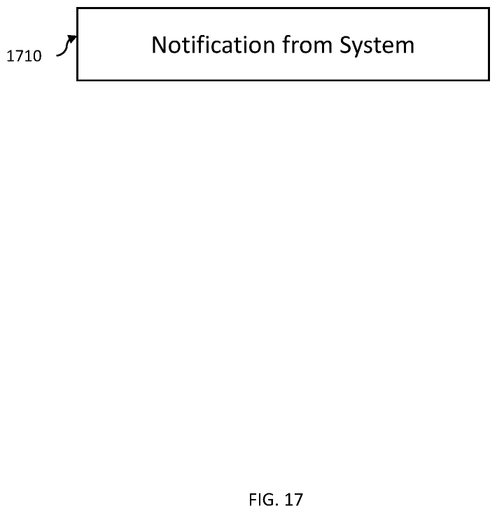

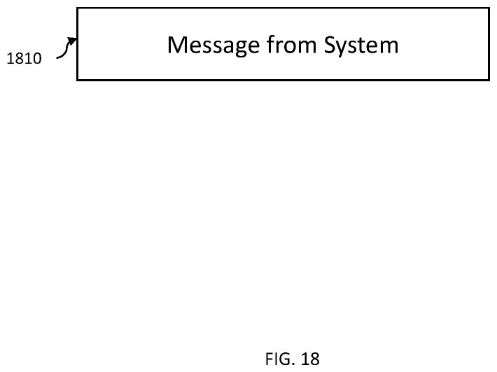

FIG. 17 and FIG. 18 illustrate example embodiments of a user interface. In some embodiments, the user interface may include notifications to the user throughout the gifting process. Such notifications can include text messages, alerts, pings, etc. For example, the system can send the user a text message to notify the user, the gift giver, that another user, the gift recipient, has created a user profile or a gift recipient profile. In some embodiments, the system can provide the use with a link to the user's profile, system generated recommendations for the user, survey, etc.

As shown in FIG. 17, the user may receive a notification from the system 1710. For example, the user may be a gift giver that is notified by the system. The notification may include a statement, for example, “Sally created a gifting profile.”

As shown in FIG. 18, the user may receive and open a message from the system 1810. For example, the message may include a link to the giftee's profile.

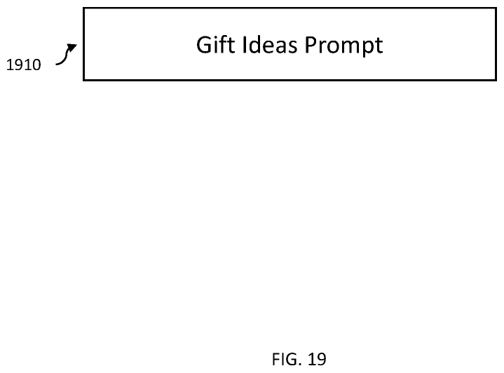

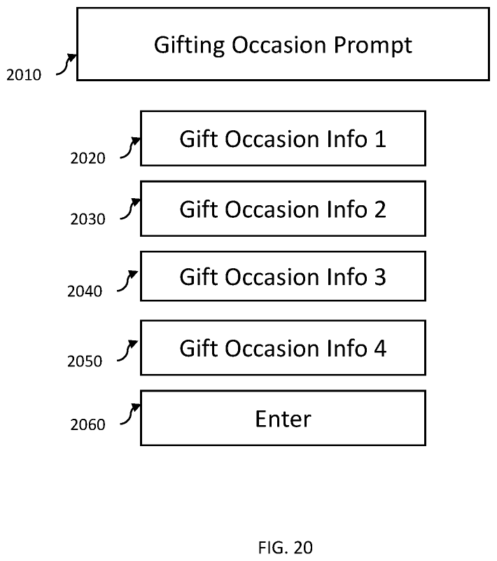

FIG. 19 and FIG. 20 illustrate example embodiments of a user interface. In some embodiments, the user interface may include a link or selectable tab that can direct the user to system generated gift recommendations for a user. In some embodiments, the user interface can include at least one prompt that may invite the user to input information regarding an upcoming gifting occasion for a user. Such information can include the occasion, date, relationship, gift budget, etc.

As shown in FIG. 19, a gift ideas prompt 1910 may be presented to the user. For example, the gift ideas prompt 1910 allow the user to see the gift ideas curated for the giftee.

As shown in FIG. 20, a gift occasion prompt 2010 may be presented to the user. The user can input gift occasion information for each gift giver. The user can input information for the gift occasion into gift occasion info one 2020, gift occasion info two 2030, gift occasion info three 2040, gift occasion info four 2050. The user may select enter 2060 to continue on in the interface. For example, the gift occasion info can include occasion, date, relationship, gift budget, etc.

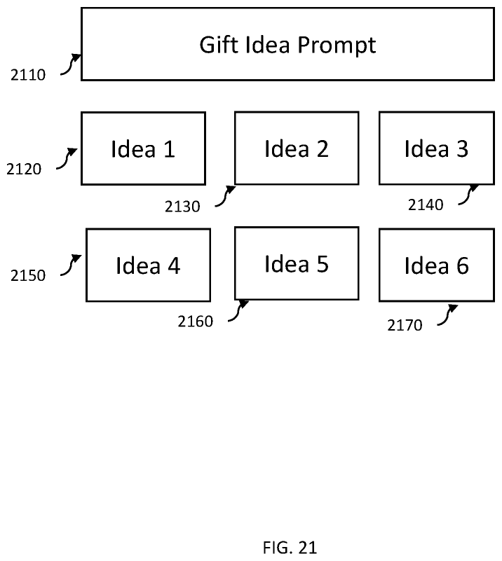

FIG. 21 illustrates an example embodiment of a user interface. In some embodiments, the user interface may include icons and questions that may allow the user to easily answer a question prompted. In some embodiments, the icon may correlate to the question prompted. For example, the user may be asked whether the user had a gift in mind. For example, the icons may correlate or resemble various categories of gift options. Such categories can include bags, jewelry, fitness, wellness, home, beauty, etc.

As shown in FIG. 21, a gift idea prompt 2110 may be presented to the user. The user may be shown gift idea options, such as gift idea one 2120, gift idea two 2130, gift idea three 2140, gift idea four 2150, gift idea five 2160, gift idea six 2170. For example, the gift options can include bags, jewelry, fitness, wellness, home, beauty, etc.

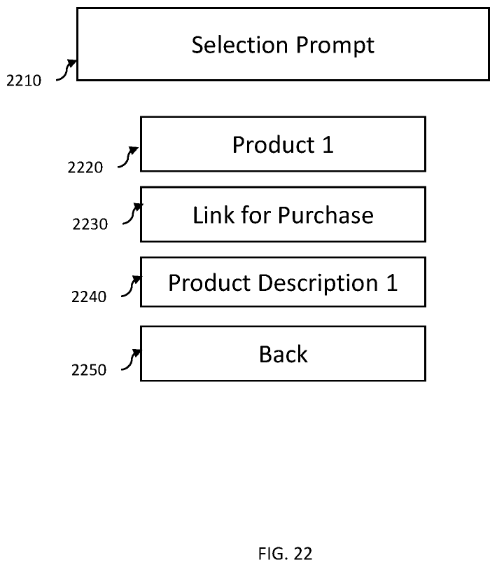

FIG. 22 illustrates an example embodiment of a user interface. In some embodiments, the user interface can include system generated gift recommendations. For example, the user interface may include an image of the system generated gift recommendations. In some embodiments, the user interface may include a link to the system generate recommendation; the link may direct the user to a website where the user may be able to purchase the system generated gift recommendation. In some embodiments, the user interface may include a selectable tab or functionality (e.g., “Add to Cart,” “Buy,” etc.) that may allow the user to purchase the system generated gift recommendation directly through the system.

As shown in FIG. 22, a selection prompt 2210 may be presented to the user. The user may be shown product options, such as product one 2220. The user may be shown a link for purchase 2230, which may allow the user to purchase the product one 2220. The user may be shown a product description 2240, which may include a description of the product the user may purchase. The user may also select back 2250 to return to a previous interface.

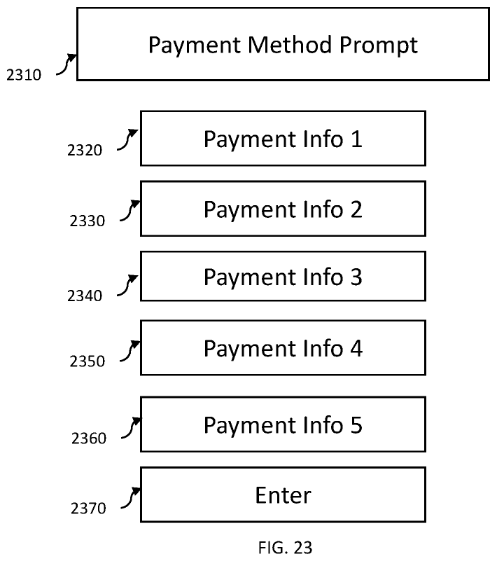

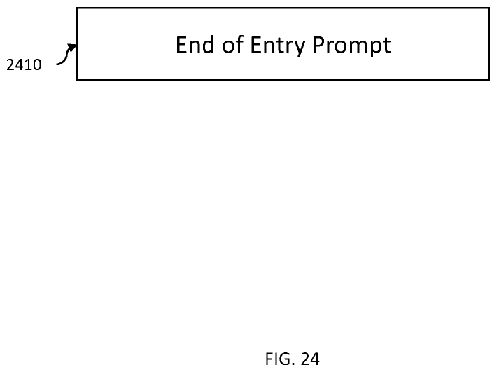

FIG. 23 and FIG. 24 illustrate example embodiments of a user interface. In some embodiments, the user interface may allow the user to input their payment method information. This may allow the user to purchase the system generated gift recommendation directly through the system in a D2C manner. In some embodiments, the user interface can include a confirmation page, which may confirm that the user has purchased a system generated gift recommendation and the system generated gift recommendation is on the way to a user. In some embodiments, the user interface can include tracking information or order confirmation information.

As shown in FIG. 23, a payment method prompt 2310 may be presented to the user. The user may input payment information into payment info one 2320, payment info two 2330, payment info three 2340, payment info four 2350, payment info five 2360. For example, the payment info may include card type, card number, name on card, expiration date, CVV, billing information, etc. The user may continue to the next interface by selecting enter 2370.

As shown in FIG. 24, an end of entry prompt 2410 may be presented to the user. For example, the end of entry prompt 2410 may include “thank you,” “gift is on the way,” etc.

In some embodiments, the system may gather data from the gift recipient. Such data can include whether the gift recipient is interested in lifestyle gifts, fashion style gifts, hosting style gifts, etc. Similarly, for example, the system may match and recommend products to the gift giver. Such recommendations may include gifts from specific brands or companies from various categories. Such recommendations may be based on the interest of the gift recipient. Similarly, for example, the system may select a gift and request feedback from the user. Such gift selected may include products from various brands or companies.

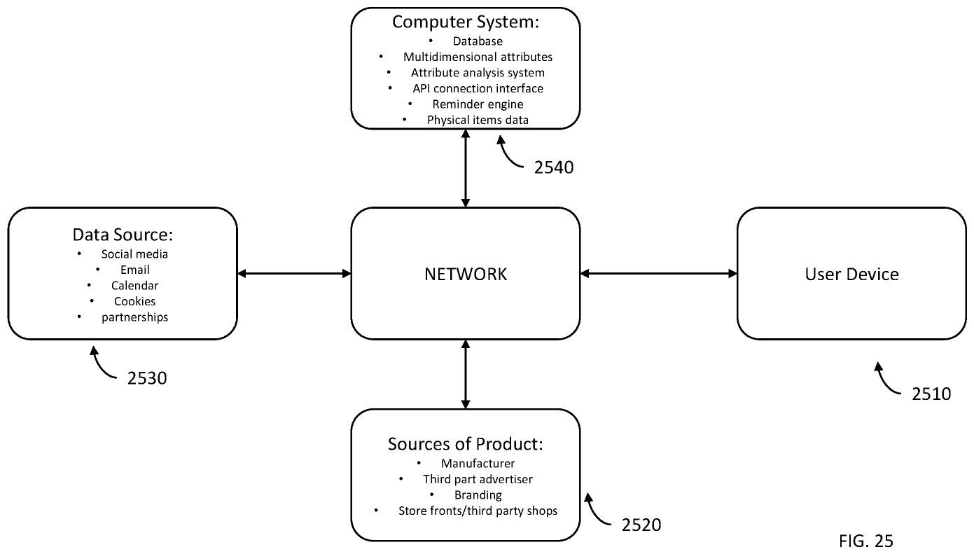

FIG. 25 is a schematic diagram illustrating an example embodiment(s) of a gift recommendation generating system. As illustrated in FIG. 25, in some embodiments, a gift recommendation generating system comprises one or more Users or User Devices 2510, at least one Product Source 2520, at least one Data Source 2530, and a Computer System 2540. The Product Source 2520 can include at least one manufacturer, at least one third party advertiser or supplier, branding, at least one store front or third-party shop, and others alike. The Data Source 2530 may include a plurality of social media data, a plurality of email data, a plurality of calendar data, a plurality of cookies, a plurality of partnership data, a plurality of physical items data, etc. The Computer System 2540 may include a database, a plurality of multidimensional attributes, an attribute analysis system, an API connection, a reminder engine, a plurality of physical items data, etc. Each of the one or more Users or User Devices 2510, Product Source 2520, Data Source 2530, and Computer System 2540 can be in communication with each other over a network.

In some embodiments, the Users or User Devices 2510 can be configured to input a plurality of user data that can be used to create a user profile.

In some embodiments, the Computer System 2540 can comprise an attribute analysis system. The attribute analysis system can be configured to analyze the user profile data and physical items data and dynamically assign at least one of the plurality of multidimensional attributes to the users based on the plurality of user profile data and to the physical items based on the plurality of physical items data. The attribute analysis system can be further configured to generate a score and rank each of the physical items based on comparing the plurality of multidimensional attributes assigned to at least one of the plurality of physical items and the plurality of multidimensional attributes assigned to at least one of the plurality of users.

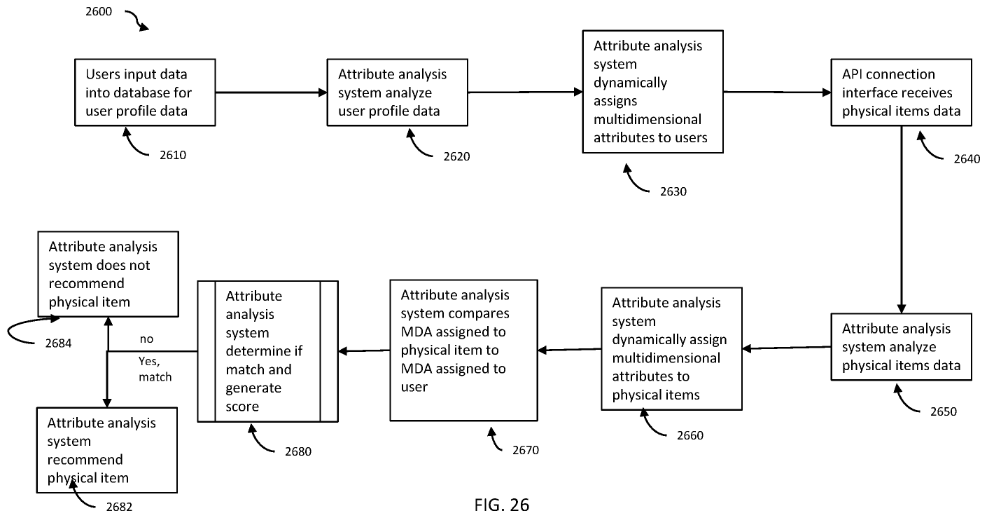

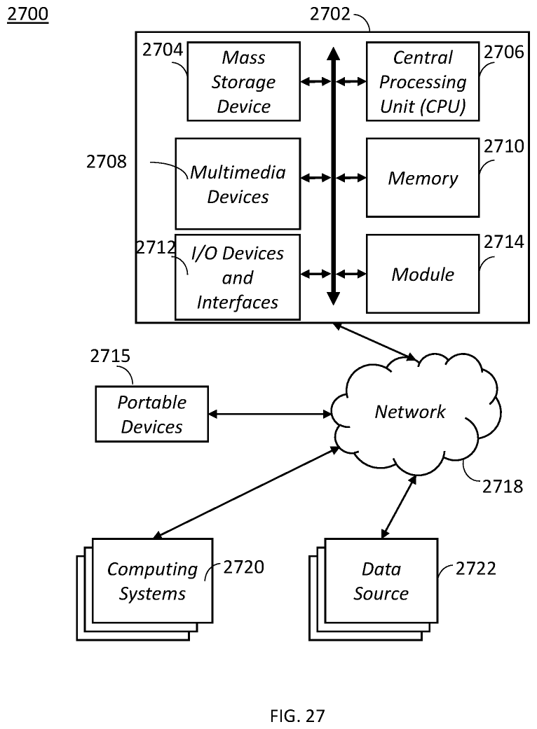

FIG. 26 is a block diagram that illustrates an example protocol or method 2600 for a system that analyzes a plurality of multidimensional attributes assigned to users and physical items and generates a gift recommendation list based on the analysis. The method 2600 can be implemented, for example, using one or more components of the system shown in FIG. 27.

At block 2610, a user may input a plurality of user profile data into a database. The database may be configured to store the plurality of user profile data. The system can use the user profile data to create a user profile for the user. The user may be the gift recipient. At block 2620, an attribute analysis system may analyze the plurality of user profile data. At block 2630, the attribute analysis system may further dynamically assign at least one multidimensional attribute to the user profile associated with the plurality of user profile data.

At block 2640, an API connection may receive an input of a plurality of physical items data associated with at least one physical item. The physical items may include sportswear, clothing, shoes, household items, outdoor items, accessories, travel items, etc. At block 2650, the attribute analysis system may analyze the plurality of physical items data. At block 2660, the attribute analysis system may dynamically assign at least one multidimensional attribute to each one of the at least one physical items. At least one of the multidimensional attributes dynamically assigned to the user profile may be the same as at least one of the multidimensional attributes dynamically assigned to the physical items. The multidimensional attributes dynamically assigned to the user profile can be compared to the multidimensional attributes dynamically assigned to the physical items. The system may generate a match upon the comparison of the multidimensional attributes dynamically assigned to the user profile and the multidimensional attributes dynamically assigned to the physical items. A match may signify that at least one of the multidimensional attributes dynamically assigned to the user profile is similar or equal to at least one of the multidimensional attributes dynamically assigned to the physical items.

At block 2670, the attribute analysis system may compare the multidimensional attributes assigned to each one of the physical items and the multidimensional attributes assigned to the user profile associated with the user. At block 2680, the attribute analysis system may determine the occurrence of a match based on whether any of the multidimensional attributes assigned each one of the physical items may be similar or equal to any of the multidimensional attributes assigned to the user profile associated with the user. At block 2680, the attribute analysis system may also generate a score for each one of the physical items. The score may be based on whether the multidimensional attributes dynamically assigned to the physical item match with the multidimensional attributes dynamically assigned to the user profile. The score associated with each one of the physical items may increase based on how many times the multidimensional attributes dynamically assigned to the physical item match with the multidimensional attributes dynamically assigned to the user profile.

The attribute analysis system may output a plurality of recommended physical items based on the score assigned to each of the plurality of physical items. At block 2682, if the system determines a match occurred, the attribute analysis system may recommend the physical item to the output. The output may include the recommended physical items in rank order based on the score associated with each of the physical items. The highest scored physical item may be the recommended physical item that the system recommends the most. At block 2684, if the system determines match did not occur, the attribute analysis system may not recommend the physical item or may rank the physical item lower on the output. The attribute analysis system may not recommend the physical item if the score associated with the physical item does not pass a threshold score.

### Computer System

In some embodiments, the systems, processes, and methods described herein are implemented using a computing system, such as the one illustrated in FIG. 27. The example computer system 2702 is in communication with one or more computing systems 2720 and/or one or more data sources 2722 via one or more networks 2718. While FIG. 27 illustrates an embodiment of a computing system 2702, it is recognized that the functionality provided for in the components and modules of computer system 2702 may be combined into fewer components and modules, or further separated into additional components and modules.

The computer system 2702 can comprise a gift recommendation engine module 2714 that carries out the functions, methods, acts, and/or processes described herein. The gift recommendation engine module 2714 is executed on the computer system 2702 by a central processing unit 2706 discussed further below.

In general the word “module,” as used herein, refers to logic embodied in hardware or firmware or to a collection of software instructions, having entry and exit points. Modules are written in a program language, such as JAVA, C or C++, PYTHON, or the like. Software modules may be compiled or linked into an executable program, installed in a dynamic link library, or may be written in an interpreted language such as BASIC, PERL, LUA, or PYTHON. Software modules may be called from other modules or from themselves, and/or may be invoked in response to detected events or interruptions. Modules implemented in hardware include connected logic units such as gates and flip-flops, and/or may include programmable units, such as programmable gate arrays or processors.

Generally, the modules described herein refer to logical modules that may be combined with other modules or divided into sub-modules despite their physical organization or storage. The modules are executed by one or more computing systems and may be stored on or within any suitable computer readable medium, or implemented in-whole or in-part within special designed hardware or firmware. Not all calculations, analysis, and/or optimization require the use of computer systems, though any of the above-described methods, calculations, processes, or analyses may be facilitated through the use of computers. Further, in some embodiments, process blocks described herein may be altered, rearranged, combined, and/or omitted.

The computer system 2702 includes one or more processing units (CPU) 2706, which may comprise a microprocessor. The computer system 2702 further includes a physical memory 2710, such as random-access memory (RAM) for temporary storage of information, a read only memory (ROM) for permanent storage of information, and a mass storage device 2704, such as a backing store, hard drive, rotating magnetic disks, solid state disks (SSD), flash memory, phase-change memory (PCM), 3D XPoint memory, diskette, or optical media storage device. Alternatively, the mass storage device may be implemented in an array of servers. Typically, the components of the computer system 2702 are connected to the computer using a standards-based bus system. The bus system can be implemented using various protocols, such as Peripheral Component Interconnect (PCI), Micro Channel, SCSI, Industrial Standard Architecture (ISA) and Extended ISA (EISA) architectures.

The computer system 2702 includes one or more input/output (I/O) devices and interfaces 2712, such as a keyboard, mouse, touch pad, and printer. The I/O devices and interfaces 2712 can include one or more display devices, such as a monitor, that allows the visual presentation of data to a user. More particularly, a display device provides for the presentation of GUIs as application software data, and multi-media presentations, for example. The I/O devices and interfaces 2712 can also provide a communications interface to various external devices. The computer system 2702 may comprise one or more multi-media devices 2708, such as speakers, video cards, graphics accelerators, and microphones, for example.

The computer system 2702 may run on a variety of computing devices, such as a server, a Windows server, a Structure Query Language server, a Unix Server, a personal computer, a laptop computer, and so forth. In other embodiments, the computer system 2702 may run on a cluster computer system, a mainframe computer system and/or other computing system suitable for controlling and/or communicating with large databases, performing high volume transaction processing, and generating reports from large databases. The computing system 2702 is generally controlled and coordinated by an operating system software, such as z/OS, Windows, Linux, UNIX, BSD, SunOS, Solaris, MacOS, or other compatible operating systems, including proprietary operating systems. Operating systems control and schedule computer processes for execution, perform memory management, provide file system, networking, and I/O services, and provide a user interface, such as a graphical user interface (GUI), among other things.

The computer system 2702 illustrated in FIG. 27 is coupled to a network 2718, such as a LAN, WAN, or the Internet via a communication link 2116 (wired, wireless, or a combination thereof). Network 2718 communicates with various computing devices and/or other electronic devices. Network 2718 is communicating with one or more computing systems 2720 and one or more data sources 2722. The gift recommendation engine module 2714 may access or may be accessed by computing systems 2720 and/or data sources 2722 through a web-enabled user access point. Connections may be a direct physical connection, a virtual connection, and other connection type. The web-enabled user access point may comprise a browser module that uses text, graphics, audio, video, and other media to present data and to allow interaction with data via the network 2718.

Access to the gift recommendation engine module 2714 of the computer system 2702 by computing systems 2720 and/or by data sources 2722 may be through a web-enabled user access point such as the computing systems' 2720 or data source's 2722 personal computer, cellular phone, smartphone, laptop, tablet computer, e-reader device, audio player, or another device capable of connecting to the network 2718. Such a device may have a browser module that is implemented as a module that uses text, graphics, audio, video, and other media to present data and to allow interaction with data via the network 2718.

The output module may be implemented as a combination of an all-points addressable display such as a cathode ray tube (CRT), a liquid crystal display (LCD), a plasma display, or other types and/or combinations of displays. The output module may be implemented to communicate with input devices 2712 and they also include software with the appropriate interfaces which allow a user to access data through the use of stylized screen elements, such as menus, windows, dialogue boxes, tool bars, and controls (for example, radio buttons, check boxes, sliding scales, and so forth). Furthermore, the output module may communicate with a set of input and output devices to receive signals from the user.

The input device(s) may comprise a keyboard, roller ball, pen and stylus, mouse, trackball, voice recognition system, or pre-designated switches or buttons. The output device(s) may comprise a speaker, a display screen, a printer, or a voice synthesizer. In addition, a touch screen may act as a hybrid input/output device. In another embodiment, a user may interact with the system more directly such as through a system terminal connected to the score generator without communications over the Internet, a WAN, or LAN, or similar network.

In some embodiments, the system 2702 may comprise a physical or logical connection established between a remote microprocessor and a mainframe host computer for the express purpose of uploading, downloading, or viewing interactive data and databases on-line in real time. The remote microprocessor may be operated by an entity operating the computer system 2702, including the client server systems or the main server system, and/or may be operated by one or more of the data sources 2722, one or more portable devices 2715, and/or one or more of the computing systems 2720. In some embodiments, terminal emulation software may be used on the microprocessor for participating in the micro-mainframe link.

In some embodiments, computing systems 2720 who are internal to an entity operating the computer system 2702 may access the gift recommendation engine module 2714 internally as an application or process run by the CPU 2706.

The computing system 2702 may include one or more internal and/or external data sources (for example, data sources 2722). In some embodiments, one or more of the data repositories and the data sources described above may be implemented using a relational database, such as DB2, Sybase, Oracle, CodeBase, and Microsoft® SQL Server as well as other types of databases such as a flat-file database, an entity relationship database, and object-oriented database, and/or a record-based database.

The computer system 2702 may also access one or more databases 2722. The databases 2722 may be stored in a database or data repository. The computer system 2102 may access the one or more databases 2722 through a network 2718 or may directly access the database or data repository through I/O devices and interfaces 2712. The data repository storing the one or more databases 2722 may reside within the computer system 2702.

In some embodiments, one or more features of the systems, methods, and devices described herein can utilize a URL and/or cookies, for example for storing and/or transmitting data or user information. A Uniform Resource Locator (URL) can include a web address and/or a reference to a web resource that is stored on a database and/or a server. The URL can specify the location of the resource on a computer and/or a computer network. The URL can include a mechanism to retrieve the network resource. The source of the network resource can receive a URL, identify the location of the web resource, and transmit the web resource back to the requestor. A URL can be converted to an IP address, and a Domain Name System (DNS) can look up the URL and its corresponding IP address. URLs can be references to web pages, file transfers, emails, database accesses, and other applications. The URLs can include a sequence of characters that identify a path, domain name, a file extension, a host name, a query, a fragment, scheme, a protocol identifier, a port number, a username, a password, a flag, an object, a resource name and/or the like. The systems disclosed herein can generate, receive, transmit, apply, parse, serialize, render, and/or perform an action on a URL.

A cookie, also referred to as an HTTP cookie, a web cookie, an internet cookie, and a browser cookie, can include data sent from a website and/or stored on a user's computer. This data can be stored by a user's web browser while the user is browsing. The cookies can include useful information for websites to remember prior browsing information, such as a shopping cart on an online store, clicking of buttons, login information, and/or records of web pages or network resources visited in the past. Cookies can also include information that the user enters, such as names, addresses, passwords, credit card information, etc. Cookies can also perform computer functions. For example, authentication cookies can be used by applications (for example, a web browser) to identify whether the user is already logged in (for example, to a website). The cookie data can be encrypted to provide security for the consumer. Tracking cookies can be used to compile historical browsing histories of individuals. Systems disclosed herein can generate and use cookies to access data of an individual. Systems can also generate and use JSON web tokens to store authenticity information, HTTP authentication as authentication protocols, IP addresses to track session or identity information, URLs, and the like.

### Additional Embodiments

In the foregoing specification, the invention has been described with reference to specific embodiments thereof. It will, however, be evident that various modifications and changes may be made thereto without departing from the broader spirit and scope of the invention. The specification and drawings are, accordingly, to be regarded in an illustrative rather than restrictive sense.

Indeed, although this invention has been disclosed in the context of certain embodiments and examples, it will be understood by those skilled in the art that the invention extends beyond the specifically disclosed embodiments to other alternative embodiments and/or uses of the invention and obvious modifications and equivalents thereof. In addition, while several variations of the embodiments of the invention have been shown and described in detail, other modifications, which are within the scope of this invention, will be readily apparent to those of skill in the art based upon this disclosure. It is also contemplated that various combinations or sub-combinations of the specific features and aspects of the embodiments may be made and still fall within the scope of the invention. It should be understood that various features and aspects of the disclosed embodiments can be combined with, or substituted for, one another in order to form varying modes of the embodiments of the disclosed invention. Any methods disclosed herein need not be performed in the order recited. Thus, it is intended that the scope of the invention herein disclosed should not be limited by the particular embodiments described above.

It will be appreciated that the systems and methods of the disclosure each have several innovative aspects, no single one of which is solely responsible or required for the desirable attributes disclosed herein. The various features and processes described above may be used independently of one another, or may be combined in various ways. All possible combinations and subcombinations are intended to fall within the scope of this disclosure.

Certain features that are described in this specification in the context of separate embodiments also may be implemented in combination in a single embodiment. Conversely, various features that are described in the context of a single embodiment also may be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination. No single feature or group of features is necessary or indispensable to each and every embodiment.

It will also be appreciated that conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. In addition, the term “or” is used in its inclusive sense (and not in its exclusive sense) so that when used, for example, to connect a list of elements, the term “or” means one, some, or all of the elements in the list. In addition, the articles “a,” “an,” and “the” as used in this application and the appended claims are to be construed to mean “one or more” or “at least one” unless specified otherwise. Similarly, while operations may be depicted in the drawings in a particular order, it is to be recognized that such operations need not be performed in the particular order shown or in sequential order, or that all illustrated operations be performed, to achieve desirable results. Further, the drawings may schematically depict one more example processes in the form of a flowchart. However, other operations that are not depicted may be incorporated in the example methods and processes that are schematically illustrated. For example, one or more additional operations may be performed before, after, simultaneously, or between any of the illustrated operations. Additionally, the operations may be rearranged or reordered in other embodiments. In certain circumstances, multitasking and parallel processing may be advantageous. Moreover, the separation of various system components in the embodiments described above should not be understood as requiring such separation in all embodiments, and it should be understood that the described program components and systems may generally be integrated together in a single software product or packaged into multiple software products. Additionally, other embodiments are within the scope of the following claims. In some cases, the actions recited in the claims may be performed in a different order and still achieve desirable results.

Further, while the methods and devices described herein may be susceptible to various modifications and alternative forms, specific examples thereof have been shown in the drawings and are herein described in detail. It should be understood, however, that the invention is not to be limited to the particular forms or methods disclosed, but, to the contrary, the invention is to cover all modifications, equivalents, and alternatives falling within the spirit and scope of the various implementations described and the appended claims. Further, the disclosure herein of any particular feature, aspect, method, property, characteristic, quality, attribute, element, or the like in connection with an implementation or embodiment can be used in all other implementations or embodiments set forth herein. Any methods disclosed herein need not be performed in the order recited. The methods disclosed herein may include certain actions taken by a practitioner; however, the methods can also include any third-party instruction of those actions, either expressly or by implication. The ranges disclosed herein also encompass any and all overlap, sub-ranges, and combinations thereof. Language such as “up to,” “at least,” “greater than,” “less than,” “between,” and the like includes the number recited. Numbers preceded by a term such as “about” or “approximately” include the recited numbers and should be interpreted based on the circumstances (e.g., as accurate as reasonably possible under the circumstances, for example ±5%, ±10%, ±15%, etc.). For example, “about 3.5 mm” includes “3.5 mm.” Phrases preceded by a term such as “substantially” include the recited phrase and should be interpreted based on the circumstances (e.g., as much as reasonably possible under the circumstances). For example, “substantially constant” includes “constant.” Unless stated otherwise, all measurements are at standard conditions including temperature and pressure.

As used herein, a phrase referring to “at least one of” a list of items refers to any combination of those items, including single members. As an example, “at least one of: A, B, or C” is intended to cover: A, B, C, A and B, A and C, B and C, and A, B, and C. Conjunctive language such as the phrase “at least one of X, Y and Z,” unless specifically stated otherwise, is otherwise understood with the context as used in general to convey that an item, term, etc. may be at least one of X, Y or Z. Thus, such conjunctive language is not generally intended to imply that certain embodiments require at least one of X, at least one of Y, and at least one of Z to each be present. The headings provided herein, if any, are for convenience only and do not necessarily affect the scope or meaning of the devices and methods disclosed herein.

Accordingly, the claims are not intended to be limited to the embodiments shown herein, but are to be accorded the widest scope consistent with this disclosure, the principles and the novel features disclosed herein.

What is claimed is:

1. A computer system for dynamically generating and displaying a product recommendation to a user by analyzing multidimensional attributes associated with a plurality of users and a plurality of physical items to generate a unique score for the plurality of physical items, each physical item having a unique identification, the computer system comprising:
one or more computer readable storage devices configured to store a plurality of computer executable instructions; and
one or more hardware computer processors in communication with the one or more computer readable storage devices and configured to execute the plurality of computer executable instructions in order to cause the computer system to:
access user profile data associated with a user of the plurality of users, wherein user profile data comprises zero-party data obtained via a dynamic user interface;
analyze, by an attribute analysis engine, user profile data to assign at least one of a plurality of multidimensional attributes to the user, wherein each of the plurality of multidimensional attributes comprises at least one of: character trait, character attribute, demographic, preference, trend, interest, descriptive label, or location;
receive, via an application programming interface from at least one third-party source, a plurality of physical items data associated with a plurality of physical items;
store the plurality of physical items data;
analyze, by the attribute analysis engine, the plurality of physical items data to assign at least one of the plurality of multidimensional attributes to at least one of the plurality of physical items;
dynamically generate, by the attribute analysis engine, a score for each of the at least one of the plurality of physical items by comparing the at least one of the plurality of multidimensional attributes assigned to the at least one of the plurality of physical items to the at least one of the plurality of multidimensional attributes assigned to the user; and
display, via the dynamic user interface, a plurality of recommended physical items based on the score assigned to each of the at least one of the plurality of physical items, wherein the plurality of recommended physical items have a score exceeding a threshold level, and wherein the plurality of recommended physical items are displayed in order based on the generated score.

2. The computer system of claim 1, wherein a second application programming interface connection interface is configured to receive a plurality of social media data about each of the plurality of users and store the plurality of social media data in a second electronic storage medium, the plurality of social media data received from at least one of the plurality of users.

3. The computer system of claim 2, wherein the attribute analysis engine is further configured to analyze the plurality of social media data and the user profile data to dynamically assign to at least one of the plurality of users at least one of the plurality of multidimensional attributes based on analysis of the plurality of social media data and the user profile data associated with at least one of the plurality of users.

4. The computer system of claim 2, wherein the plurality of social media data includes a plurality of calendar data.

5. The computer system of claim 4, wherein the computer system further comprises a reminder engine configured to analyze the plurality of calendar data and store at least one calendar item.

6. The computer system of claim 5, wherein the reminder engine is further configured to generate a reminder based on the at least one calendar item.

7. The computer system of claim 1 further comprises a user profile data generator configured to access a plurality of survey questions stored in a survey bank database and display at least one of the plurality of survey questions to the at least one of the plurality of users, receive a plurality of inputs from at least one of the plurality of users to generate the user profile data for each of the plurality of users.

8. The computer system of claim 7, wherein the user profile data includes at least one of the plurality of inputs from the at least one of the plurality of users.

9. The computer system of claim 1, wherein the plurality of users includes a first user and a second user.

10. The computer system of claim 1, wherein the attribute analysis engine is further configured to increase the score for each one of at least one of the plurality of physical items when at least one of the plurality of multidimensional attributes assigned to at least one of the plurality of physical items equals at least one of the plurality of multidimensional attributes assigned to at least one of the plurality of users.

11. The computer system of claim 1, wherein the attribute analysis engine is further configured to dynamically weigh at least one of the plurality of multidimensional attributes assigned to at least one of the plurality of users.

12. The computer system of claim 11, wherein the attribute analysis engine assigns a greater weight to a first multidimensional attribute of the at least one of the plurality of multidimensional attributes than a weight assigned to a second multidimensional attribute of the at least one of the plurality of multidimensional attributes.

13. The computer system of claim 12, wherein the attribute analysis engine is further configured to increase the score for each of the at least one of the plurality of physical items when at least one of the plurality of multidimensional attributes assigned to at least one of the plurality of physical items equals the first multidimensional attribute of the at least one of the plurality of multidimensional attributes.

14. A computer-implemented method for dynamically generating and displaying a product recommendation to a user by analyzing multidimensional attributes associated with a plurality of users and a plurality of physical items to generate a unique score for the plurality of physical items each physical item having a unique identification, the computer-implemented method comprising:
collecting user profile data for each of the plurality of users and storing the user profile data in one or more computer readable storage devices configured to store a plurality of computer executable instructions;
accessing user profile data associated with a user of the plurality of users, wherein the user profile data comprises zero-party data obtained via a dynamic user interface;
analyzing, by an attribute analysis engine, the user profile data to assign at least one of a plurality of multidimensional attributes to the user, wherein each of the plurality of multidimensional attributes comprises at least one of: character trait, character attribute, demographic, preference, trend, interest, descriptive label, or location;
receiving, via an application programming interface from at least one third-party source, a plurality of physical items data associated with a plurality of physical items;
storing the plurality of physical items data;
analyzing, by the attribute analysis engine, the plurality of physical items data to assign at least one of the plurality of multidimensional attributes to at least one of the plurality of physical items;
dynamically generating, by the attribute analysis engine, a score for each of the at least one of the plurality of physical items by comparing the at least one of the plurality of multidimensional attributes assigned to the at least one of the plurality of physical items to the at least one of the plurality of multidimensional attributes assigned to the user; and
displaying, via the dynamic user interface, a plurality of recommended physical items based on the score assigned to each of the at least one of the plurality of physical items, wherein the plurality of recommended physical items have a score exceeding a threshold level, and wherein the plurality of recommended physical items are displayed in order based on the generated score.

15. The computer-implemented method of claim 14, wherein a second API connection interface receiving a plurality of social media data about each of the plurality of users and storing the plurality of social media data in a second electronic storage medium, the plurality of social media data received from at least one of the plurality of users.

16. The computer-implemented method of claim 15, wherein the attribute analysis engine analyzing the plurality of social media data and the user profile data and dynamically assigning to at least one of the plurality of users at least one of the plurality of multidimensional attributes based on analysis of the plurality of social media data and the user profile data associated with at least one of the plurality of users.

17. The computer-implemented method of claim 14, wherein the attribute analysis engine increasing the score for each one of the at least one of the plurality of physical items when at least one of the plurality of multidimensional attributes assigned to at least one of the plurality of physical items equals at least one of the plurality of multidimensional attributes assigned to at least one of the plurality of users.

18. The computer-implemented method of claim 14, wherein the attribute analysis engine dynamically weighing at least one of the plurality of multidimensional attributes assigned to at least one of the plurality of users.

19. The computer-implemented method of claim 18, wherein the attribute analysis engine assigning a greater weight to a first multidimensional attribute of the at least one of the plurality of multidimensional attributes than a weight assigned to a second multidimensional attribute of the at least one of the plurality of multidimensional attributes.

20. The computer-implemented method of claim 19, wherein the attribute analysis engine increasing the score for each of the at least one of the plurality of physical items when at least one of the plurality of multidimensional attributes assigned to at least one of the plurality of physical items equals the first multidimensional attribute of the at least one of the plurality of multidimensional attributes.
